(19) United States
(12) Patent Application Publication
(10) Pub. No.: US 2025/0117848 A1
(43) Pub. Date: Apr. 10, 2025

(54) INTEGRATED PLATFORM FOR DIGITAL ASSET REGISTRATION, TRACKING AND VALIDATION

(71) Applicant: Figure Lending Corporation, New York, NY (US)

(72) Inventors: Chris Karlsson, Charlotte, NC (US); Daniel Wallace, New York, NY (US); Leah Price, Riviera Beach, FL (US); Nicole Beaulieu, Reno, NV (US); Valerie Wagner, Helena, MT (US); David Kneisly, Los Angeles, CA (US)

(21) Appl. No.: 18/890,562

(22) Filed: Sep. 19, 2024

Related U.S. Application Data
(63) Continuation of application No. PCT/US2023/016089, filed on Mar. 23, 2023.
(60) Provisional application No. 63/323,665, filed on Mar. 25, 2022.

(51) Int. Cl. G06Q 40/03; H04L 9/00; H04L 9/08; H04L 9/32

(52) U.S. Cl. CPC G06Q 40/03; H04L 9/0825; H04L 9/3213; H04L 9/3236; H04L 9/50

(57) ABSTRACT

A blockchain-based lending or loan processing platform is provided. The platform comprises: a blockchain onboarding system comprising a smart contract execution environment (CEE). The blockchain onboarding system is configured to: (1) automatically process loan data from a loan origination system (LOS) for virtual execution of one or more loan contracts within the CEE, and the loan data comprises a plurality of loan-related facts; (2) encrypt the loan-related facts to generate a plurality of encrypted facts associated with one or more loan assets; and (3) generate a plurality of hashes for the encrypted facts. The hashes are recorded on a blockchain, and the combinations of each encrypted fact with its corresponding hash are deposited in an encrypted object store (EOS) separate from the blockchain. The platform also comprises a digital asset registration tool (DART) to track substantially in realtime the control, transfers, assignments and/or ownership of controllable electronic records.

### CROSS-REFERENCE

This application is a continuation application of International Application No. PCT/US2023/016089, filed Mar. 23, 2023, which claims priority to U.S. Provisional Application Ser. No. 63/323,665, filed Mar. 25, 2022, which is entirely incorporated herein by reference.

### BACKGROUND

Blockchain systems are increasingly used to record digital assets and/or transaction data via distributed computing devices. Blockchains beneficially allow secure, distributed storage of event and transaction data that is verifiable and resistant to unauthorized usage. However, existing systems for transacting with others via a blockchain or otherwise may not provide sufficient information about the transaction counterparty or counterparties. Additionally, current blockchain-based systems may not be suitable to support the traditional financial services industry where private data integrity is required. For example, current platforms may not be suitable for enabling participating parties (e.g., financial institutions) to use private data with a public blockchain.

### SUMMARY

A need exists for platforms and systems allowing for the use of off-chain client-side agreements in conjunction with on-chain data and contracts. The present disclosure is directed to systems and methods for financial transactions based on blockchain technology. In particular, platform and systems of the present disclosure may be used to keep confidential data off the blockchain, while still using the blockchain for data integrity (e.g., distributed, immutable, trustless).

The present disclosure provides a platform for digital asset validation, tracking and registration. In some embodiments, the platform may be a blockchain-based lending or loan processing platform. The platform may comprise a blockchain onboarding system allowing loan originators to integrate their loan origination system (LOS), custody and servicing into the blockchain. For instance, digital assets may be onboarded to the blockchain by the execution of client-side contracts that the originator writes to consume origination data, being verified by the platform for its completeness, and the output data may include recorded facts in an encrypted object store (EOS) private to and hosted by the originator.

The blockchain onboarding system may comprise a smart contract execution environment (CEE) which records hashed representations of documents, data, transactions and client-side contracts to the blockchain. Modification or updates of the data only occur through further contract execution on a unique, predefined data structure (e.g., scope), with checks on the input hash of data from the object store against the blockchain to ensure no external data modification has taken place. In this way, the truth of the data can be verified without the need for trust in the individual originator's data store. The system and methods disclosed herein may beneficially provide portfolio level credit, performance and related statistics as well as the ability to drill into a single loan packet, view an exception report, payment history, and the like. The blockchain onboarding system beneficially allows for the use of off-chain client-side agreements in conjunction with on-chain data and contracts. In particular, the systems and methods herein may advantageously enable participating financial institutions to use private data with a public blockchain.

In an aspect, a blockchain-based lending or loan processing platform is provided. The platform may comprise: a blockchain onboarding system comprising a smart contract execution environment (CEE). The blockchain onboarding system is configured to: (1) automatically process loan data from a loan origination system (LOS) for virtual execution of one or more loan contracts within the CEE, and the loan data comprises a plurality of loan-related facts; (2) encrypt the loan-related facts to generate a plurality of encrypted facts associated with one or more loan assets; and (3) generate a plurality of hashes for the encrypted facts. The hashes are recorded on a blockchain, and the combinations of each encrypted fact with its corresponding hash are deposited in an encrypted object store (EOS) separate from the blockchain.

In some embodiments, each fact corresponds to a single or discrete piece of data whose hash is to be recorded on the blockchain. In some embodiments, the CEE is configured to keep confidential data relating to the one or more loan assets off from the blockchain, while maintaining the ability to use the blockchain for ensuring data integrity. In some cases, the hashes of the encrypted facts are recorded on the blockchain, and wherein the encrypted facts are not recorded on the blockchain. In some cases, the EOS is local to or part of the CEE.

In some embodiments, the plurality of loan-related facts comprise credit scores, borrower information or profile, electronic copies of signed security instruments, copies of electronic promissory notes (eNotes), third party review (TPR) diligence results, and/or terms of a loan. In some embodiments, the loan data is originated by an originating party, and wherein the platform is configured to enable the originating party to create a unique wallet having a root key pair comprising of a public key and a private key. In some cases, the loan-related facts are encrypted using the originating party's public key. In some instances, the hashes of the encrypted facts are recorded on the blockchain along with the originating party's public key and timestamps. In some cases. the private key is useable by the originating party or another party who is given permission by the originating party, to decrypt the encrypted facts stored in the EOS.

In some embodiments, the blockchain contains records of all transactions including loan onboarding and loan asset transfers. In some embodiments, a collection of loan-related facts collectively constitute a token. In some cases, the token comprises a non-fungible token (NFT). In some instances, each token is assigned a unique identifier. In some cases, the platform is configured to designate ownership at the token level. In some cases, the platform is configured to bifurcate ownership of a token between data owner and value owner. For instance, the platform recognizes the value owner as an entity that is entitled to the monetary value of the loan asset encompassing the token(s), and permits the value owner to transfer value rights to other parties. For example, the platform recognizes the data owner as an entity that controls the facts encompassed in the token. In some cases, the platform is configured to permit only the data owner to affect the facts in the token, by adding one or more facts, changing one or more facts, or deleting one or more facts. For instance, the platform is configured to permit the data owner to share ownership freely such that there can be multiple data owners, and wherein each data owner among the multiple data owners is required to individually sign off on any subsequent changes to the token data after the token has been onboarded to the blockchain. In some cases, the platform is configured to permit the data owner to grant read-only access to the token data for one or more other non-owner parties. For example, the platform is configured to enable the one or more other non-owner parties to decrypt the token and view/access the facts within the token, without allowing the non-owner parties to make any changes to the token data on the blockchain. In some instances, any attempted changes made by the non-owner parties that have only read-only access will not be accepted or validated for recording on the blockchain.

In some cases, the platform recognizes an originating party as an entity that creates and onboards the token through the CEE, and wherein the originating party is by default initially the data owner and value owner of the token. In some instances, the platform is configured to assign a unique public-private key pair to the originating party. In some examples, the public key is useable by the originating party to create a digital signature on the token. For instance, the platform allows the digital signature to be verified and validated by the private key that is connected to the public key and that is associated with the originating party. In some instances, the token is encrypted, and the private key is useable to decrypt and view/access the facts within the token. In some instances, the public key is included in the token, as well as any subsequent authorized amendments or alterations to the token. In some cases, any authorized transfers of ownership of the token are tracked or traced by an integrated digital asset registration tool (DART). In some instances, the platform is configured to permit authorized subsequent amendments or alterations to the token to be made only by an entity whose digital signature matches that of the current data owner of the token. In some cases, the platform is configured to reject amendments or alterations that are proposed by any entity whose digital signature does not match that of the current data owner of the token.

In some embodiments, the platform further comprises a digital asset registration tool (DART) connected to the platform. The DART is an integrated registry that is configured to track substantially in realtime the control, transfers, assignments and/or ownership of controllable electronic records, such as promissory notes (eNotes) associated with the loan contracts. In some cases, the DART is designed to obviate the need for paper assignments, bills of sale or other documentation of transfers of security agreements, or physical document deliveries. In some cases, the DART is designed to obviate the need to manually register eNotes and loans with any additional intermediary systems. In some cases, the DART is configured to enable intra-party blockchain-based transfer of fully-digital, tokenized mortgage assets from a transferor to a transferee, and provide validation that a perfected super-priority control has been granted to the transferee. In some cases, the EOS is configured to share the encrypted facts and metadata with a loan marketplace module, and wherein loan transactions taking place via the loan marketplace module are recorded substantially in realtime using the DART.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, and the accompanying drawings (also “Figure” and “FIG.” herein), of which:

FIG. 1 shows an example of a blockchain-based lending or loan processing platform, in accordance with some embodiments of the present disclosure.

FIG. 2 shows an example of a scope proposed/generated by a contract execution environment (CEE) and a scope processed and recorded on a blockchain.

FIG. 3 schematically shows a contract execution environment (CEE), in accordance with embodiments of the present disclosure.

FIG. 4 schematically illustrates a loan onboarding architecture for onboarding loan asset to a blockchain.

FIG. 5 schematically illustrates an application architecture of the platform in accordance with embodiments of the present disclosure.

FIG. 6 shows an example of a platform comprising a Digital Asset Registration Tool (DART), in accordance with embodiments of the present disclosure.

FIG. 7 shows an example of a user interface (UI) provided by a portfolio manager.

FIG. 8A schematically illustrates a platform with blockchain-based loan validation and an integrated eNote Registration, in accordance with embodiments of the present disclosure.

FIG. 8B schematically illustrates the data sharing mechanism in the platform, in accordance with embodiments of the present disclosure.

FIG. 9 schematically illustrates an exemplary computer system that is programmed or otherwise configured to implement one or more methods provided herein.

### DETAILED DESCRIPTION

While various embodiments have been shown and described herein, it will be obvious to those skilled in the art that such embodiments are provided by way of example only. Numerous variations, changes, and substitutions may occur to those skilled in the art without departing from the scope of the present disclosure. It should be understood that various alternatives to the embodiments described herein may be employed.

The present disclosure provides a platform for digital asset validation, tracking and registration. In some cases, assets or items such as financial assets (e.g., loans), titles, artwork and the like may be represented on blockchains as on-chain asset or digital assents such as Non-Fungible Tokens (NFTs) where the blockchain records indicate ownership of such distinct digital assets.

In some embodiments, the platform may be a blockchain-based lending or loan processing platform for financial assets. The platform may comprise a blockchain onboarding system allowing loan originators to integrate their loan origination system (LOS), custody and servicing into or onto the blockchain. For instance, digital assets may be onboarded to the blockchain by the execution of client-side contracts that the originator writes to consume origination data, being verified by the platform for its completeness, and the output data may include recorded facts in an encrypted object store (EOS) private to and hosted by the originator.

The blockchain onboarding system may comprise a smart contract execution environment (CEE) which records hashed representations of documents, data, transactions and client-side contracts to the blockchain. Modification or updates of the data only occur through further contract execution on a data object (e.g., scope), with checks on the input hash of data from the object store against the blockchain to ensure no external data modification has taken place. In this way, the truth of the data can be verified without the need for trust in the individual originator's data store. The provided system and method may beneficially provide portfolio level credit, performance and related statistics as well as the ability to drill into a single loan packet, view an exception report, payment history, and the like. The blockchain onboarding system beneficially allows for the use of off-chain client-side agreements in conjunction with on-chain data and contracts. In particular, systems and methods herein may advantageously enable participating financial institutions to use private data with a public blockchain.

The users of the platform may comprise clients, companies, organizations, investors, staked token holders, delegators, developers, researchers, maintainers, and various other participants. Participants may include individuals or entities that transact on the blockchain to register, custody and trade assets. In some cases, participants may pay transaction fees when executing transactions on the blockchain. In some cases, the Client Contract Execution Environment (CEE) may assist in facilitating private communications and processes between participants that are hashed prior to being included in the immutable record held by validators.

The participants may include validators and delegators that may be on the buy-side, sell-side, other financial services companies, or third-party validators who independently host the blockchain. In some cases, any participant can become a validator or delegator. Participants who hold Hash (Hash utility token that is used to pay for transactions (gas fees), staking, and grants) may additionally participate by delegating their stake to validators to receive rewards. In some cases, any participant may buy or sell Hash directly by visiting any participating Hash exchange.

A validator may be a validating node on the blockchain network. A validator may propose and validate transactions on the blockchain network. In some cases, validators may stake Hash to become part of the active validators on the network (e.g., the top 50 validator nodes within the network by total stake are selected as the active set of validators) and are a foundational element for Hash holders that want to delegate their stake and share in rewards produced by the network's fee distribution framework. The blockchain may provide benefits to incentivize validations. For instance, validators may participate in the security and control of the network and may be able to earn additional staking rewards through commissions charged as well as bonuses for proposing transactions to be accepted by the network. In some cases, active validators may each be given a turn to propose a block to be committed using a round-robin assignment. Validators may choose the minimum gas price that they will accept in order to process a proposed transaction which allows validators to organically modify the cost to use the network.

The term “stake” as utilized herein, may generally refer to a hash that has been delegated to a validator to share in the risks and rewards of participating in the consensus mechanism on the blockchain network. The term “delegation” as utilized herein may generally refer to staking Hash with a validator to be used by that validator as voting power. For most holders of Hash delegation is an easy and relatively safe method of sharing in the ownership and rewards of the network.

The participants may include asset creator or originator (e.g., loan originator) who put digital assets on the blockchain. Asset creators may register and custody digital assets on the blockchain through the use of client-side contracts or the loan origination system. In some cases, the blockchain client-side contracts may take encrypted data from the asset creator and transform that information into predetermined object structure then encrypt the data in the creator's own private encrypted object store (e.g., EOS) with object hashes recorded on the blockchain through the loan scope data module (e.g., loan scope or facts hashes) as described later herein. In addition to onboarding digital assets, asset creators may fund, finance, sell, and service assets on the blockchain.

The participants may include entities who purchase or finance assets on the blockchain (e.g., banks, funds, etc.), entities who securitize assets, investors who purchase the bonds, and various other entities such as an omnibus bank that provides a bridge between fiat and the blockchain.

### Blockchain Onboarding System

In an aspect, a blockchain-based lending or loan processing platform is provided. The platform may comprise: a blockchain loan onboarding system comprising a smart contract execution environment (CEE). The blockchain onboarding system is configured to: (1) automatically process loan data from a loan origination system (LOS) for virtual execution of one or more loan contracts within the CEE, and the loan data comprises a plurality of loan-related facts; (2) encrypt the loan-related facts to generate a plurality of encrypted facts associated with one or more loan assets; and (3) generate a plurality of hashes for the encrypted facts. The hashes are recorded on a blockchain, and the combinations of each encrypted fact with its corresponding hash are deposited in an encrypted object store (EOS) separate from the blockchain.

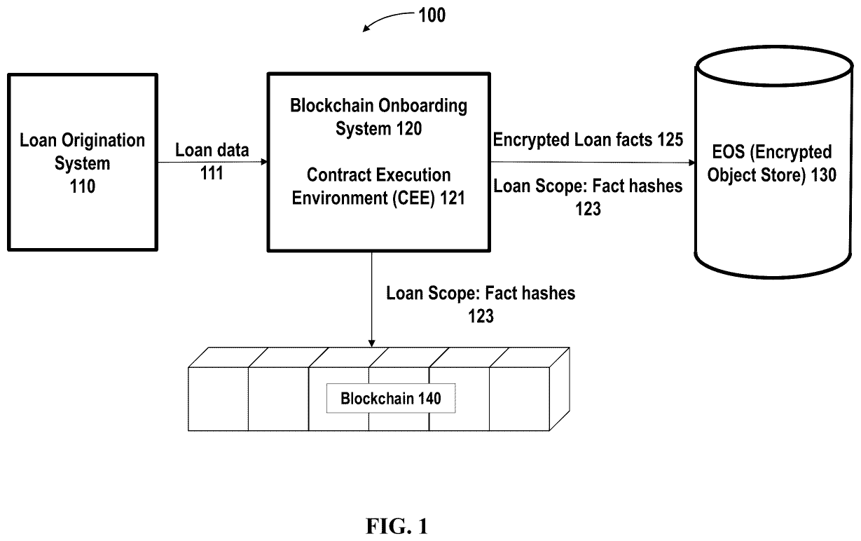

FIG. 1 shows an example of a blockchain-based lending or loan processing platform 100, in accordance with some embodiments of the present disclosure. The platform 100 may comprise a blockchain onboarding system 120 allowing loan originators to integrate their loan origination system (LOS) 110, custody and servicing into or with the blockchain 140. In some embodiments, digital assets may be onboarded to the blockchain 140 by the execution of client-side contracts that the originator writes to consume origination data, verify its completeness, and output data as recorded facts 125 or a combination of encrypted facts 125 and fact hash 123 in an encrypted object store (EOS) 130. In some embodiments, the EOS 130 may be private to and hosted by the loan originator thereby allowing for improved privacy. The data for the asset may contain sensitive and/or private information. The sensitive and/or private information may be stored off-chain in the EOS. The on-chain scope metadata may contain the ownership information of the digital assets and may be pooled or tokenized using a marker module as described later herein.

The client-side contracts may be different from blockchain-based smart contracts. The client-side contracts execution environment may execute only in the contract execution environment of the parties participating in the contract, and operate only on data stored in the EOS. A record of the contract execution is memorialized to the blockchain using the Blockchain data model (e.g., scope data model) which, in turn, records the scope data object to chain through the use of blockchain-based smart contracts.

Client side contracts may differ from smart contracts in that they keep the data private between parties off chain and allow a structure to record agreed upon state data to the blockchain. Smart contracts in comparison may be running on the blockchain and require the validators to have access to the data which can be problematic for consumer-based transactions due to data privacy concern.

The blockchain onboarding system as described herein may be utilized to register a new asset on a blockchain as an on-chain digital asset. The digital asset may be represented using a metadata module and a scope data structure as described later herein. The metadata module may be utilized to preserve off-chain data privacy (e.g., Personal Identifiable Information (PII)) while allowing for recording the results of the asset data state (represented by the data hash) on the blockchain. The blockchain onboarding system may be configured to automatically perform operations thereby simplifying a process of registration of a new asset on a blockchain (e.g., minting process).

In some embodiments, the blockchain onboarding system 120 may comprise a contract execution environment (CEE) 121 which records fact hashes (e.g., hashed representations of all documents, data, transactions and client-side contracts) 123 to the blockchain 140. The blockchain onboarding system 120 may be configured to: (1) automatically process loan data 111 from a loan origination system (LOS) 110 for virtual execution of one or more loan contracts within the CEE 121, where the loan data 111 comprises a plurality of loan-related facts; (2) encrypt the loan-related facts to generate a plurality of encrypted facts 125 associated with one or more loan assets; and (3) generate a plurality of hashes 123 for the encrypted facts, wherein the hashes 123 are recorded on a blockchain. Combinations of each encrypted fact 125 with its corresponding hash 123 may be deposited in an encrypted object store (EOS) 130 separate from the blockchain 140.

In some embodiments, the digital assets may comprise a digital loan asset. The loan data 111 may be associated with one or more loan assets. The loan data may comprise a plurality of loan-related facts including, for example, credit scores, borrower information or profile, electronic copies of signed security instruments, copies of electronic promissory notes (eNotes), third party review (TPR) diligence results, terms of a loan, and/or various other transaction (e.g., specific monthly payment), detail (e.g., applicant credit score), document or information related to a loan.

In some embodiments, the blockchain onboarding system 120 may process the loan data 111 for virtual execution of one or more loan contracts within the CEE 121 and encrypt the loan-related facts to generate a plurality of encrypted facts 125 associated with one or more loan assets.

In some embodiments, the CEE 121 may transform the loan data 111 into encrypted data to be stored in the encrypted object store (EOS) and may record the object hash-ids (e.g., fact hash in a scope object) on the blockchain. A hash-id may be a cryptographic hash of the contents of facts (e.g., files, documents, etc.) in on-chain, immutable transactions. In some cases, a hash value (e.g., fact hash) of a fact (e.g., document's content) may be used as a globally unique identifier (URI) or name (URN) for that content. In some cases, the encrypted data stored in the EOS may be encrypted Fact-Fact Hash combination comprising both the actual fact data (e.g., a PDF of the security instrument) 125 and the hash of the fact data (e.g., 489sdfkennwoeinv9) 123.

In some cases, the CEE may store the loan data into the EOS in predetermined data object structures. In some cases, the predetermined object structures may be defined by a loan data model. These unique object structures may be used to efficiently store the state data in the data object store.

In some embodiments, the object structure may comprise a scope object established in the EOS that may correspond to a set of facts of the loan data i.e., scope dataset. For instance, the loan data may be ordered and arranged into one or more scope datasets. A scope object in the EOS may be the unit for storing the loan data. As an example, an origination scope may be associated with origination-related facts such as all the details, documents and facts of the origination process (e.g., PDF copies of wet-signed documents, an applicant's credit score, etc.). In another example, a servicing scope may comprise servicing-related facts such as all the details, documents and facts of the servicing process (e.g., loan payments and documents). Depending on the nature of the digital asset, different digital assets may have different types (e.g., loan, title, art, fund, share class, etc.) and/or number of scopes. For example, a mortgage asset may comprise an eNote scope which may comprise the electronic note record, along with associated metadata.

In some embodiments, a collection of loan-related facts may collectively constitute a scope object established on a blockchain. The blockchain scope object may be a non-fungible token (NFT) comprising a hash of a set of facts. For instance, the loan-related facts may be bucketed into one or more scope datasets corresponding to one or more blockchain scope objects. Each fact in a scope dataset may be hashed such that a set of fact hashes may be generated for the scope datasets which are included in a blockchain scope object. A blockchain scope object may record the ownership, fact name, fact hashes, and various other status of the fact or the scope. A blockchain scope object may not include the original loan-related facts. Instead, a scope object may comprise fact hashes 123. The fact hashes 123 may be the hashes of a subset of facts or hashes of the scope dataset. A blockchain scope object may also be referred to as a token which can be utilized or construed interchangeably throughout the specification.

In some cases, a scope may be created with all facts at one time (e.g., all origination information onboarded at once with an Origination Scope). Alternatively or additionally, the facts may be added over time (e.g., new servicing information is added to an existing Servicing Scope).

In some embodiments, a single loan may have a single scope (e.g., every fact of the lending transaction in one scope). Alternatively, a single loan may have multiple scopes. As an example, a dual-scope loan may comprise an Origination Scope and a Servicing Scope, and the eNote may be contained in the Origination Scope.

In some embodiments, the CEE 121 may create one or more loan scopes 123 by hashing on one or more scope datasets. In some cases, the LOS 110 may order and organize the loan data 111 into one or more scope datasets and transmit the scope datasets to the blockchain onboarding system 120. The one or more loan scopes 123 may be proposed/generated by the CEE to be recorded on a blockchain 140. The proposed loan scopes 123 may be processed by the blockchain layer 140 such as by performing security validation checks on the proposed loan scopes, finalizing and recording the validated scopes on the blockchain. In some cases, additional information such as Block ID may be included in the scope upon validation. Metadata or other information such as timestamps may also be added when the scope is recorded on the blockchain.

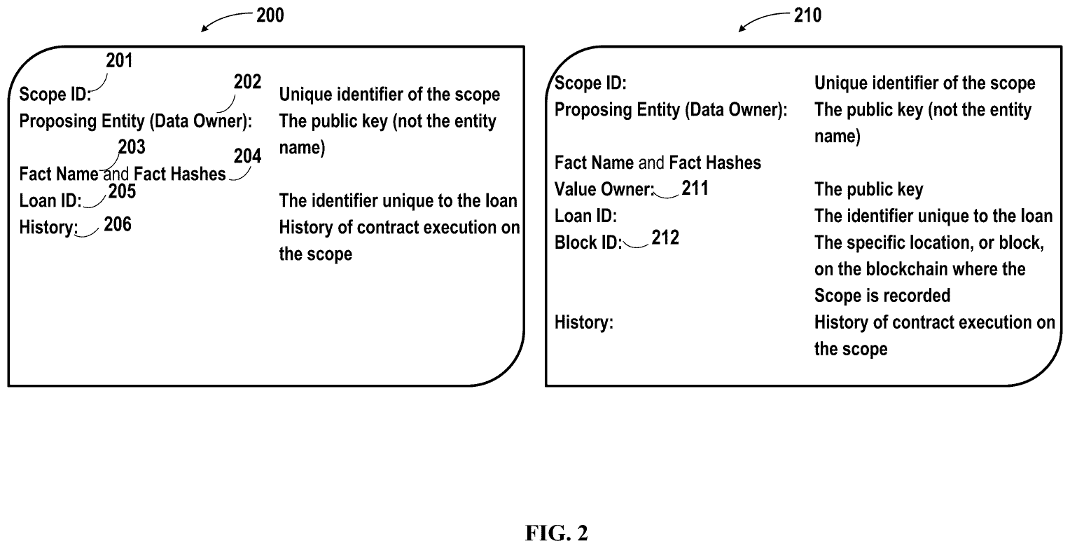

The proposed scope or the recorded scope may comprise fact hashes instead of the original facts or scope datasets. FIG. 2 shows an example of a scope 200 proposed by the CEE and the corresponding scope 210 that is processed and recorded on a blockchain. As shown in the example, the loan scope may not include the original loan-related facts (e.g., PDF document). The loan scope may comprise a fact name 203 which may be the name or identifier related to a Fact. For example, when the fact is a PDF security instrument, the Fact Name of the fact may be “signed security instrument.”

A scope 200 or 210 may comprise fact hash(es) 204. A fact hash may be an algorithm-generated fingerprint of a piece of data (fact). The fingerprint is a string of characters that represents the data. A hash may be created using a hashing algorithm (e.g., SHA-256), and the hash may be uniquely associated with the piece of data. In some cases, a change to a single character in the dataset may result in a different hash value. For example, if a Fact is a PDF security instrument, then the Fact Hash is “adbkel838dfkjlbleisyuyf,” which is a set of characters generated by the hashing algorithm to uniquely represent the PDF security instrument.

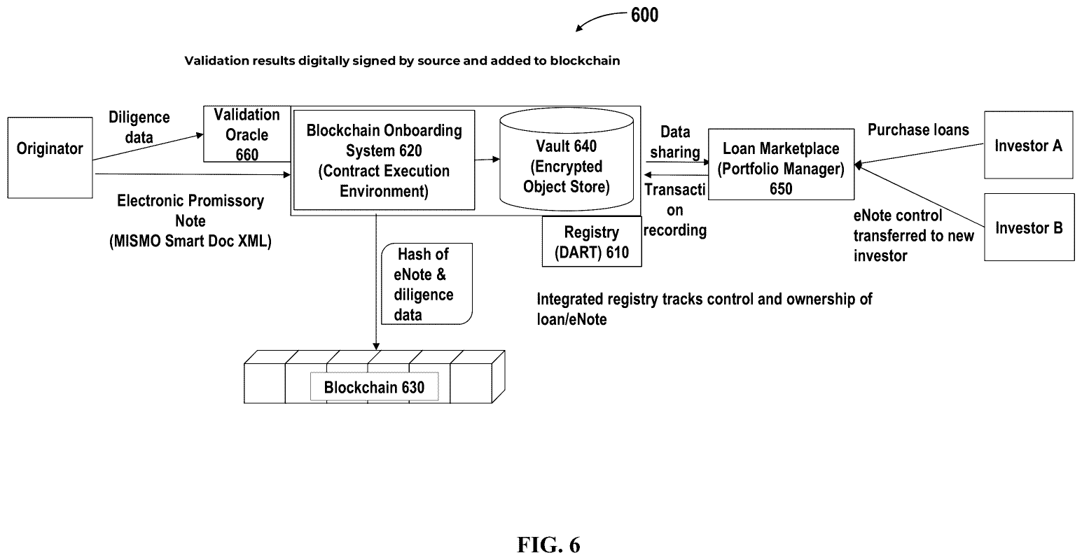

The scope 200 constructed by the CEE may be assigned a unique identifier, e.g., Scope ID 201. In some embodiments, the loan data model may assign a Universally Unique Identifiers (UUIDs) to each scope. This may beneficially allow for joint contract execution and data sharing between a variety of applications (e.g., Servicing and the Portfolio Manager Applications as shown in FIG. 6).

The scope 200 may contain information about ownership rights. The system herein may track ownership at the scope level by including an entity who owns the digital asset (e.g., loan data) or the scope dataset. The ownership of the scope may include data owner 202 and/or value owner 211. In some cases, the platform is configured to bifurcate ownership of a token between data owner and value owner.

A data owner 202 may refer to an entity that owns and controls the scope dataset (e.g., subset of facts encompassed in the scope). In some cases, the platform may be configured to permit only the data owner to affect the facts in the token, such as by adding one or more facts, changing one or more facts, or deleting one or more facts. In some cases, the platform may be configured to permit the data owner to share ownership freely such that there can be multiple data owners, and each data owner among the multiple data owners may be required to individually sign off on any subsequent changes to the scope dataset after the scope has been recorded on the blockchain. In some cases, the platform may be configured to permit the data owner to grant read-only access to the token data (e.g., actual fact) for one or more other non-owner parties. In some cases, any changes attempted to be made by the non-owner parties that have only read-only access will not be accepted or validated for recording on the blockchain.

A value owner 211 may refer to an entity that is entitled to the monetary value of the digital asset (e.g., loan asset) encompassing the scope(s) or scope dataset(s). A value owner may be permitted to transfer value rights to other parties.

In some cases, an originating party may be the default or initial data owner and value owner of a scope. An originating party may refer to an entity that creates and onboards the scope through the CEE. In some cases, the platform may allow both the data ownership and the value ownership to be transferred and shared freely. The variable ownership and permission structures allow parties flexibility to accommodate all of the relationships involved in a digital asset's lifecycle from origination to securitization.

The value owner or the data owner may have control of the scope. For instance, with a single-scope loan, the data owner may have control pursuant to ESIGN/UETA, as that entity is the only one capable of affecting the facts in the scope, including the transferable record therein.

The proposed scope 200 may comprise a digital signature identifying the data owner or proposing entity 202. In the proposed scope or the recorded scope 210, the proposing entity may not be identified by name thereby preserving privacy or PII of the proposing entity. The proposing entity may be identified by a unique public key (e.g., alkdfjlkj23434ienfildf), which serves as a digital signature confirming the identity of the entity that proposes the scope. The originator or the originating party (e.g., Data Owner) may digitally sign the proposed scope using a public key assigned to the originating party. In some cases, each entity that joins the blockchain network may be assigned a unique public-private key pair and may keep its private key secret. When preparing a scope, the originator may use the private key to create the digital signature on the scope. The digital signature can be verified and validated by the public key that is connected to the private key and that is associated with the signing entity, i.e., the originator. The inclusion of the originator's or data owner's public key in the proposed scope (or amendment thereto) may beneficially ensure that it is the originator or data owner that is proposing the scope (or amendment).

In some cases, to meet digital signature requirements, data providers may be required to provide the following information: 1) entity's certificate, 2) canonicalized original data and 3) signature across the data. The entity's certificate allows any other third party to confirm the information was signed using a private key specific to the data provider. For instance, the entity will register their certificate with the Blockchain Certificate Registry. The certificate may include any required chain of trust to the certificate authority. As an example, the public key may be ASNI OID: prime256v1 and NIST CURVE: P-256. The canonicalized original data may be the original data package sent, in a standard canonical form. The signature across the data may be the outcome of the canonical original data sent through a checksum (e.g., SHA256) and cryptographically signed with a private key.

An exemplary process to generate a signature may comprise canonicalizing the message; running the canonicalized message through a SHA256 checksum; cryptographically signing the checksum with the certificate private key (e.g., the signature output may be in ASN.1 DER format); encoding the signed checksum (e.g., by Base64); inserting the encoded signed checksum into the signature response header.

To validate this signature, the platform may use the certificate's public key to view the original SHA256 checksum, and run a checksum on the data used and compare the result. Both checksums should be identical as long as the underlying data has not been changed. The operation of using the certificate public key to view the checksum may verify the source of the data, and the operation of comparing the checksums may verify that the data sent from the source is used to generate the financial asset.

The signature validation operation may be performed by the Blockchain post on-boarding. In some cases, invalid signatures may not block the Service flow. In some cases, when invalid signatures are determined, the Signature Validator process may provide alerting and update loan validation messages.

In some cases, the platform may be configured to permit authorized subsequent amendments or alterations to the scope to be made only by an entity whose digital signature matches that of the current data owner of the scope. In some cases, the platform may be configured to reject amendments or alterations that are proposed by any entity whose digital signature does not match that of the current data owner of the scope. As mentioned above, the blockchain layer may receive the proposed/generated scope 200 from the CEE and process the proposed scope such as by performing security validation checks on the scope. For instance, the blockchain layer may check and confirm that the validity of the data owner's digital signature is included in a proposed scope. For example, for initial creation of a scope, the originator is the default data owner therefore the originator's public key is, by default, valid. When an amendment to an existing scope is being made, the blockchain layer may check and confirm that the digital signature of the proposing entity matches the public key of the current data owner of the scope being amended. If the proposing entity's digital signature does not match the public key of the current Data Owner, the blockchain layer may reject the proposed scope change because the proposing entity is not the Data Owner and has no authority to amend the scope data.

After validation, the proposed scope may be finalized, time-stamped, and recorded on the blockchain. In some cases, the finalized scope 210 may comprise a value owner 211 identified by the public key assigned to the value owner, a block ID 212 identifying the specific location, or block, on the blockchain where the scope is recorded in addition to the data in the proposed scope 200. The blockchain layer may transmit a copy of the recorded finalized scope to the CEE.

In some embodiments, a scope 200, 210 may also comprise a loan ID 205 that is an identifier uniquely associated with a loan asset. In some embodiments, a scope 200 may comprise a history 206 of contract execution on the scope. Alternatively, the history may be recorded on the blockchain as a metadata scope. In some cases, the history 206 may comprise data inputs and outputs of contracts executed on the scope, participants involved (e.g., identified by public key), hash of contract code and the like.

Referring back to FIG. 1, in some embodiments, one or more scope datasets for each onboarding contract may be created by the Loan Origination System (LOS) 110. The LOS may order and organize a loan asset into one or more scope datasets. An originator may transmit (e.g., via the LOS-CEE connection) the relevant scope dataset, command, and digital signature to the CEE 121. A scope dataset may include a set of the Facts, such as the borrower's personal information and a PDF of the security instrument.

In some embodiments, scope data may be transmitted to the CEE along with a Scope Command, which identifies the proposed scope and action. For example, the command “onboard_new_loan” may be used to create a new loan-related scope. For example, upon execution of a contract, a scope object may be established in the EOS 130, containing the full record of the execution of the contract and the head state of the facts (data output by the contract) in the scope, and the fact hashes (e.g., fact-fact hash combination 123, 125). A blockchain scope object may be established on the blockchain 140 substantially concurrently. The blockchain scope object can be the same as those described in FIG. 2. For example, the originator may be designated as the value owner of the asset in the scope.

The CEE 121 may be configured to keep confidential data relating to the one or more loan assets off the blockchain, while maintaining the ability to use the blockchain for ensuring data integrity. The CEE 121 may construct one or more loan scopes 123 based on the one or more scope datasets as described above. For instance, the CEE may generate the unique identifier for a scope. The CEE may be configured to generate a fact hash for each fact in the scope datasets using a hashing algorithm and associate the fact hash to each Fact. As described above, only the hashes of the encrypted facts may be recorded on the blockchain, and the encrypted facts may not be recorded on the blockchain. The loan scope 123 may also include a public key of the originating party. The CEE may then transmit the proposed loan scope 123 to the blockchain 140.

The blockchain 140 may receive the proposed loan scope 123 and process the loan scope by performing security validation checks on the proposed scopes, finalizing and recording the validated scopes on the blockchain. In some cases, the platform may be configured to permit authorized subsequent amendments or alterations to the scope to be made only by an entity whose digital signature matches that of the current data owner of the scope. In some cases, the platform may be configured to reject amendments or alterations that are proposed by any entity whose digital signature does not match that of the current data owner of the scope. For example, hashes of the encrypted facts may be recorded on the blockchain along with the originating party's public key, timestamps, Block ID or other data as described above. The blockchain layer may check and confirm that the validity of the data owner's digital signature is included in a proposed scope. For example, for initial creation of a scope, the originator is the default data owner therefore the originator's public key is, by default, valid. When amendment to an existing scope is being made, the blockchain layer may check and confirm that the digital signature of the proposing entity matches the public key of the current data owner of the scope being amended. If the proposing entity's digital signature does not match the public key of the current Data Owner, the blockchain layer may reject the proposed scope change because the proposing entity is not the Data Owner and has no authority to amend the scope data.

After validation, the blockchain 140 may finalize, time-stamp and record the scopes on the blockchain. In some cases, the blockchain 140 may add to the finalized scope a value owner identified by the public key that is assigned to the value owner, a block ID identifying the specific location, or block, on the blockchain where the scope is recorded. The blockchain 140 may transmit a copy of the recorded finalized scope to the CEE 121. In some cases, value ownership of a scope may be recorded on the blockchain through a Marker established on-chain. A Marker module provides an ownership structure for managing tokenized value backed by assets or other tokenized units of value denominated as unit(s) of coin. The Marker may be tokenized, allowing for fractional ownership of a scope.

The facts and relevant data to be stored in the EOS may be encrypted. The encryption may be conducted by the CEE 121 or the blockchain onboarding system 120 (e.g., a blockchain software development kit (SDK)). For instance, the CEE may encrypt the Fact-Fact Hash combination using the originator's public key, and then transmit the encrypted Fact-Fact Hash combinations to the Encrypted Object Store (EOS) 130. The CEE may use any suitable encryption method. For example, in some instances, Elliptic Curve Integrated Encryption Scheme (ECIES) may be used to encrypt an asset before it is stored in the EOS. The ECIES is an integrated encryption scheme which uses the following functions: Key Agreement (Function used for the generation of a shared secret by two parties); Key Derivation Function (Mechanism that produces a set of keys from keying material and some optional parameters); Encryption such as a Symmetric encryption algorithm; Message Authentication Code (Data used in order to authenticate messages); and Hash (e.g., SHA-256).

In some embodiments, the loan data may be originated by an originating party, and the platform may be configured to enable the originating party to create a unique wallet having a root key pair comprising of a public key and a private key. The loan-related facts may be encrypted using the originating party's public key. The private key may be useable by the originating party or another party who is given permission by the originating party, to decrypt the encrypted facts stored in the EOS.

In some cases, when a token/fact hash is encrypted, the private key may be useable to decrypt the token and view/access the facts within the token. The public key may be included in the token or blockchain scope object, as well as any subsequent authorized amendments or alterations to the token. In some cases, any authorized subsequent transfers of rights in the token are tracked or traced by an integrated digital asset registration tool (DART).

The EOS 130 may receive the encrypted loan facts 125 and fact hashes 123. In some cases, the encrypted loan facts 125 and fact hashes 123 may be arranged as Fact-Fact Hash combinations. A Fact-Fact Hash combination may comprise both the actual fact data (e.g., a PDF of the security instrument) and the hash of the fact data (e.g., 489sdfkennwoeinv9). The Fact-Fact Hash combination may be stored in the EOS which can be a secure repository, or vault. In some cases, only the originator can access the encrypted Fact-Fact Hash combinations by decrypting the encrypted Fact-Fact Hash combinations using the originator's private key.

In an example, a borrower signs an eNote in the lender's eClosing system or LOS 110. The loan data 111 including the eNote file such as the secure XML file with associated borrower signature and relevant metadata, along with the Scope Command (“onboard_new_loan”) and the lender's digital signature, may be routed by the eClosing system or LOS 110 to CEE 121 for creation of an eNote Scope.

The CEE 121 may (i) create a hash of the eNote and transmit an encrypted Fact-Fact Hash combination (e.g., the encrypted eNote file and the hash of the eNote file) to the EOS vault 130; and (ii) transmit a proposed eNote scope to the blockchain layer 140.

It should be noted that although the loan scope including the fact hashes is illustrated as being transmitted to both the EOS 130 and the blockchain 140 in FIG. 1, the loan scope data transmitted to the EOS may sometimes include the fact hashes of the fact (e.g., hash of the eNote file) whereas the loan scope data transmitted to and recorded on the blockchain may include other information such as data owner, value owner (e.g., lender is the default Data Owner and Value Owner), block ID in addition to the Fact Name-Hash combinations as described above. In some cases, the Fact-Fact Hash combination stored in the EOS and the loan scope recorded on the blockchain (e.g., CEE scope database) may be associated by the Fact Name.

The blockchain layer 140 may validate, finalize, and record the finalized eNote Scope on the blockchain. The authoritative or finalized scope recorded on the blockchain may include Scope ID, Data Owner(s), Value Owner, and Fact Name-Hash combinations. The encrypted Fact-Fact Hash combination (e.g., encrypted eNote file and hash of the eNote file) may be maintained securely in the lender's EOS vault 130 as an authoritative eNote file. The term “authoritative” may generally refer to a file, a fact, a data object such as a scope object that has been validated and/or finalized.

Authorized access or change of the encrypted scope, fact or the Fact-Fact Hash combinations may be controlled by distributing the key-pair to an entity. In some embodiments, the platform may be configured to enable the originating party of loan data to create a unique wallet having a root key pair comprising of a public key and a private key. The loan-related facts may be encrypted using the originating party's public key. The private key may be useable by the originating party or another party who is given permission by the originating party, to decrypt the encrypted facts stored in the EOS. In some cases, the platform may be configured to permit authorized subsequent amendments or alterations to the scope to be made only by an entity whose digital signature matches that of the current data owner of the scope. In some cases, the platform may be configured to reject amendments or alterations that are proposed by any entity whose digital signature does not match that of the current data owner of the scope.

In some cases, a contract execution may operate on a single loan scope, consisting of key-value pairs where the value object may be defined, for example, using a protocol buffer (e.g., protobuf). In some cases, when a token/fact hash is encrypted, the private key may be useable to decrypt the token and view/access the facts within the token. The public key may be included in the token or blockchain scope object, as well as any subsequent authorized amendments or alterations to the token.

For instance, the encrypted Fact-Fact Hash combinations may be securely stored in the EOS 130. The Data Owner may access a Fact (e.g., the XML eNote file) in the EOS through a user interface hosted by the CEE 121, or through another application. The Fact-Fact Hash combinations may be encrypted using a public-private key encryption system as described elsewhere herein. The originator's public key may be used to initially encrypt the Fact-Fact Hash combination, and the resulting encrypted Fact-Fact Hash combinations may be stored in the EOS. In some cases, only the originator's private key can decrypt the cipher data and allow the originator to view the actual Fact (e.g., the XML eNote file) in the Fact-Fact Hash combination.

In some cases, a data owner may be permitted to grant read-only access to other parties. For instance, the CEE in connection with the EOS may replicate the shared data into that other party's EOS, and the other party may access the data and decrypt it with their private key. That other party then has read-only access, in that they can decrypt and view the data, but they may not authoritatively affect the data on the blockchain. As described above, the blockchain may check and verify the signature and if the party's digital signature on a proposed amendment to the relevant scope does not match the digital signature of the Data Owner, the proposed amendment may not be validated for recording on the blockchain.

In some cases, the authoritative set of Facts remains in the data owner's EOS, and only the Data Owner may have the authority to amend the scope that includes the authoritative Fact Name-Fact Hash combinations associated with that set of Facts.

A recorded or authoritative scope may be altered. The alteration may comprise amending a fact associated with a scope (e.g., a fact as the scope dataset), changing the data owner and/or value owner of a scope. In some cases, changes to an authoritative scope-related information such as the Fact Name-Fact Hash combinations, Data Owners, or Value Owners may be accomplished via the CEE or by direct interface with the blockchain layer. For an alteration to be executed to completion, the proposing entity for the alteration may be required to have the appropriate ownership rights. For example, only the data owner may have the permission or authority to amend a fact in a scope dataset or a fact associated with a scope. Similar to the process of creating a scope as described above, the Data Owner may submit the relevant scope dataset (including the amended fact), the appropriate scope command, and the Data Owner's digital signature to the CEE. The CEE may then (i) encrypt and transmit to the EOS the appropriate Fact-Fact Hash combinations and (ii) construct and transmit to the blockchain layer the proposed scope. Prior to recording the proposed (amended) scope, the blockchain layer may ensure that the digital signature of the proposing entity matches that of the current Data Owner of the scope being proposed (amended). If the proposing entity's digital signature does not match that of the current Data Owner, the proposed scope may be rejected as the proposing entity is not the Data Owner and has no authority to amend the scope data.

In some cases, the recorded (amended) scope may contain metadata regarding the creation and amendment of the scope. For instance, the metadata may comprise scope commands, inputs/outputs of a contract execution, and prior versions of Fact-Fact Hash combinations.

In some cases, a current data owner may have the authority to change or modify which entity/person should be designated as the data owner of a scope. In some cases, a current value owner may have the authority to change which person/entity should be designated as the value owner of a scope. In some cases, when a transaction is a more complex transaction, the Value Owner may use a “marker” to execute the change. A marker is a smart contract that can be programmed for various uses, including designating Value Owner status of a scope. The marker is controlled by an “administrator,” which may designate which entity is the Value Owner of the marker's assets.

In some cases, updates to Scope may be performed in sessions with details persisted in a Session. A Session may contain context for the recording of these records linking a set of records into a common process or execution associated with a specification indicating allowed and required values. For instance, a session may contain a specification that details constraints on parties that are required to sign, inputs, and outputs that can be recorded. Each Scope may contain a list of allowed specifications that may be used. The Blockchain onboarding system herein may provide services that make it easy to refer to confidential documents by its hash-id, and encrypt and store those documents in a database where they are indexed by their hash-id. The encryption-key is specific for the owner or client of that document. When a contract requires the exchange of such a document, the service may re-encrypt the document with a key associated with the business partner receiving that document.

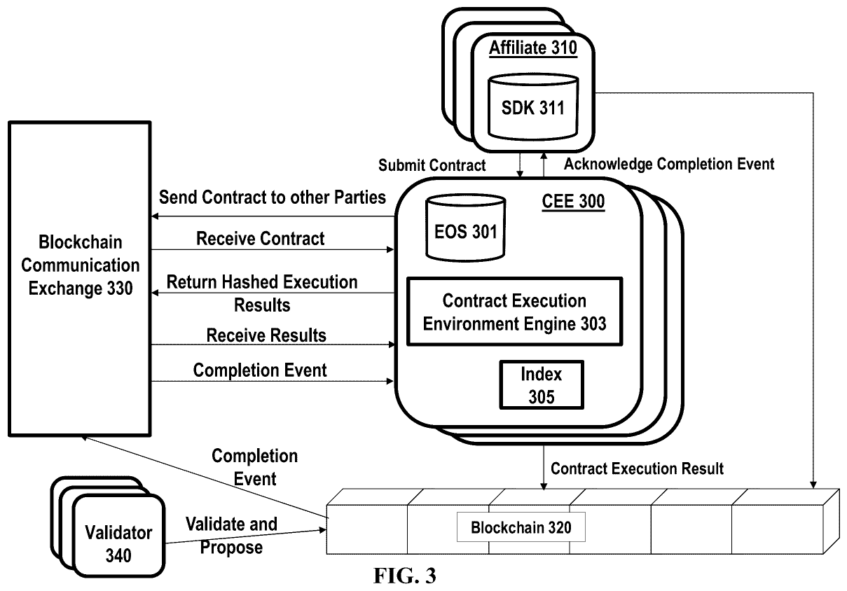

FIG. 3 schematically shows a contract execution environment (CEE) 300, in accordance with embodiments of the present disclosure. In some embodiments, the platform and/or the blockchain onboarding system may be implemented in a virtual cloud environment. One or more components or modules may be provided as container applications. The CEE may assist in the complex process of hashing of data, maintenance of immutable objects, signature orchestration between multiple parties and various other services, processes as described elsewhere herein. For instance, loan scope dataset(s) may be transmitted to, and stored and managed through, the CEE 300. The CEE may be the data management system that an affiliate (e.g., lender) uses, either via direct interface with CEE or via connection between CEE and another application, such as an LOS or SDK 311, to onboard, update, access, and share data and facts in a scope.

In some embodiments, the CEE may comprise a plurality of components including, for example, a client-side contract execution engine 303, a locally-hosted encrypted object store (EOS) 301, an index 305 into the encrypted object store, and a communication exchange for orchestrating multi-party contract execution with other parties' own CEE. In the cloud environment, the index 305 may comprise a distributed search and analytics engine. The CEE may comprise facilities that can easily refer to documents by their hash-id, and to encrypt and store those documents in an Encrypted Object Store (EOS). Those encrypted documents are indexed by their hash-id and/or optionally by selected document attribute values. The document attribute values may beneficially allow a user to aggregate documents based on common attributes without revealing their sensitive content.

The Encrypted Object Store (EOS) 301 may be an affiliate's (e.g., lender) gateway to the blockchain layer directly. For example, the EOS may be the lender's vault for data, facts, and documents. The vault may be self-hosted by the lender, or by a third-party data custodian. The EOS may store the actual, reproducible, encrypted Facts (i.e., data and documents), such as an XML eNote record, in a secure vault.

In some embodiments, each CEE instance may communicate with a blockchain node to submit transactions (contract execution hash records) to the blockchain. Applications may use client-side CEE and object stores for preserving the privacy and confidentiality of Personally Identifying Information (PII), sensitive data, and information related to non-fungible tokens. A hash commitment of the information and its state may be captured in the scope data model as described herein. The CEE provides a tool for structuring data to save on chain and serves as a side-chain information workflow manager where the scope data model-based database functions as the on-chain state store.

The blockchain communication exchange component 330 may manage the secure communications between business partners to exchange information required to fulfill the contract. This communication may flow through an asynchronous mail-box system and event stream where the messages are authenticated and encrypted by the two parties' keys.

Entities and organizations may utilize the Contract Execution Environment to execute contracts creating single or multi-party agreements. Entity identity and data encryption may make use of public-private key pairs. Entities may be known to each other and share data with each other through their public keys. Contracts and asset data may be forwarded to all entities participating in the contract by public key identifier. Entities may provide an implementation of an Encrypted Object Store (EOS) where encrypted data related to their public key is stored. Contract execution may consume data from the entity EOS, and the results of the contract executions may be returned to the submitting entity's execution environment. In some cases, the hash sum of the Contract execution results, i.e. the cryptograph hash of its content, may be submitted to the blockchain 320 (in the form of the scope data object) where they are validated and committed to the blockchain. The blockchain may emit events notifying entities the contract has been committed on the blockchain. An index 305, local to the entity, may be updated with the new contract information. This information is used later for searching and querying the data.

The blockchain layer 320 may comprise the blockchain, where scope object (e.g., a proposed scope containing Fact Hashes) may be processed by the blockchain and authoritatively recorded. The blockchain is the immutable, publicly-available source of truth for the existence, history, and timing of any scope and fact therein.

The validator 340 may be a validating node on the blockchain network. A validator may propose and validate transactions on the blockchain network. In some cases, validators may stake Hash to become part of the active validators on the network (e.g., the top 50 validator nodes within the network by total stake are selected as the active set of validators) and are a foundational element for Hash holders that want to delegate their stake and share in rewards produced by the network's fee distribution framework

An affiliate 310 may use the SDK 311 to encrypt data prior to saving to the Encrypted Object Store 301 before it is used in contract execution. An Affiliate 310 may be a participant in the transaction and may invoke a contract. The affiliate may be any participant in a transaction.

In some cases, the affiliate 310 may use the SDK 311 to encrypt the message or loan data, and/or create a set of audience cryptograms (ApubK[n] Cryptogram) for sharing the data, executing contracts. An audience cryptogram set is a list of participants that are granted permission to decrypt the message or loan data. Following are exemplary processes of utilizing the EOS encryption scheme for encrypting messages, and processing encrypted messages in Client Contracts.

The audience cryptogram may be submitted to the contract in a transient data space. The Encrypted Message and Message Metadata may be passed to permissioned participants and is stored in their Encrypted Object Store. The client contract run may use its NpubK to determine if it is in the ApubK[n] Cryptogram set. If the contract is not a valid ApubK[n] Cryptogram audience participant, the contract throws an exception and the transaction is rejected. The client contract extracts the Tag, EpubK, and Encrypted DEK from its ApubK[n] Cryptogram into memory. The ECIES shared secret may be generated to decrypt the Encrypted DEK.

The same Key Agreement function (KA) used to encrypt the DEK is followed. During decryption, the KA function uses the EpubK from the cryptogram and the contract's NprivK to generate a Secret. The Key Derivation Function (KDF) uses the Secret and the EpubK encoded as a byte array parameter to generate the Message Authentication Code key (MAC Key) and the Encryption Key (ENC Key). With the MAC Key, the Encrypted DEK, and the invoking Affiliate's UUID a new Tag is computed and compared with the Tag from the ApubK[n] Cryptogram. If the tags do not match, the contract throws and exception and the transaction is rejected. With the ENC Key, the Encrypted DEK is decrypted into a clear DEK. The Encrypted Message from the DIME (data instance with metadata and encryption (DIME) is decrypted using the DEK resulting in a Clear Message.

The client contract processes the Clear Message by: message validation, altering the message, reading the DIME Message Metadata (e.g. asset ID, information about the message like key value sets) and including or altering the message based on the metadata.

When the client contract is done processing the Clear Message, it is encrypted with the DEK resulting in a new Encrypted Message. The DEK is destroyed from memory. The audience cryptograms are processed resulting in a set of audience cryptograms containing only participants that are privileged to decrypt the message. The client contract wraps the filtered cryptogram set, along with Message Metadata in a Message Audience DIME. Finally, the client contract wraps the Encrypted Message and Message Metadata in a DIME.

The CEE 300 can be used for onboarding loan data as described above. In some cases, the CEE and its components may be used for onboarding and managing any general document. In an exemplary process of onboarding loan or a document, an affiliate 310 may submit a request to add a contract (e.g., document) to the vault 301. The submitter may be the owner and may include their public key along with the document. A unique UUID is generated and assigned to the document by the CEE engine 303. The unique ID may be used when requests are made to check-out, check-in, or verify the documents. The system 300 may create a digitally altered copy of the document. This copy may be returned to the owner where it can be viewed and shared by the owner. The CEE engine 303 may generate keys that can be used to encrypt the authoritative copy once it has been generated. These keys may be retained by the CEE 300 to ensure only the system is able to decrypt the authoritative copy on the owner's request. A digitally altered authoritative copy of the document is created and encrypted with the keys. This copy may also be returned to the owner but only the encrypted version. If the owner does not have a copy of the keys, they may be unable to decrypt the authoritative copy without using the system 300. A record of the document is memorialized to the blockchain. For example, a recorded loan scope object may comprise the following fields: UUID, Owner's public key, Document State (Checked-in/Checked-out), Hashed representations of the original document, value owner, Block ID, as described above. The UUID, the copy, and the encrypted authoritative copy may be returned to the owner.

In a check-out process, the owner of the document may submit a request to checkout a document from the vault 301. The owner includes their public key in the request in addition to the UUID and encrypted authoritative copy returned to them when the document was added to the vault. The encrypted authoritative copy may be hashed and compared with the hash from the blockchain to ensure the document hasn't been altered. The status is also checked to ensure the document is currently checked in. The keys used to originally encrypt the document may be retrieved from the vault. Using the keys, the authoritative copy is decrypted. A status change of Checked-out is memorialized to the blockchain. The decrypted authoritative copy is returned to the owner.

In a check in process, the owner of the document submits a request to check a document back in to the vault. The owner again includes their public key in the request in addition to the UUID and decrypted authoritative copy. The authoritative copy is encrypted using the original keys, hashed, and compared with the hash from the blockchain to ensure the document hasn't been altered. The status is also checked to ensure the document is currently checked out. A new digitally altered copy of the document is created. This copy will be returned to the owner where it can be viewed and shared by the owner. New keys are generated that will be used to encrypt the authoritative copy once it has been generated. These keys will be retained by the system to ensure only the system will be able to decrypt the authoritative copy on the owner's request. A digitally altered authoritative copy of the document is created and encrypted with the new keys. This encrypted copy will again be returned to the owner. An updated record of the document, including the updated checked-in status, is memorialized to the blockchain. The UUID, the copy, and the encrypted authoritative copy are returned to the owner.

In some embodiments, the Software Development Kit (SDK) 311 provided by the platform herein may be a Contract Execution SDK consists of a collection of JVM based libraries that help manage interactions with Blockchain 320. For instance, the SDK 311 may process and arrange the data into “scopes” as defined above. In some cases, the SDK contains a docker-compose environment that allows for running a complete local stack. In some cases, the SDK is responsible for executing contracts amongst one or more participants. After successful contract execution, the result may be a collection of blockchain protobuf messages. All of the records may be encrypted and stored in EOS. At this stage messages can be memorialized to the blockchain with the Blockchain HTTP or gRPC interface. Optionally, the Blockchain event stream may be read to asynchronously detect changes made to scopes previously submitted. The blockchain 320 or CEE 300 may persist the records in a system for easy search-ability at a later point in time post execution. For instance, the protobuf indexer may accomplish this by converting the protobuf into an, optionally filtered, key-value JSON structure. A custom protobuf descriptor is provided that supports a hierarchical whitelisting/blacklisting of nested protobuf messages.

In some cases, the SDK 311 may encrypt all data sent to Encrypted Object Store (EOS) 301 using an encrypted scheme (e.g., ECIES and the DIME format) as described elsewhere herein. If all audience members on that request reside on the owner's EOS, the data may be stored and may not be replicated to any other affiliate's EOS. When there's audience members that are owned by a remote EOS, the data may be replicated to those other affiliate environments. The DIME standard defines an encryption scheme so that if the data fell into the wrong hands, it can not be decrypted back into the plaintext version. The EOS itself may be a storage and replication mechanism for the data and it may not have the necessary keys in order to decrypt data.

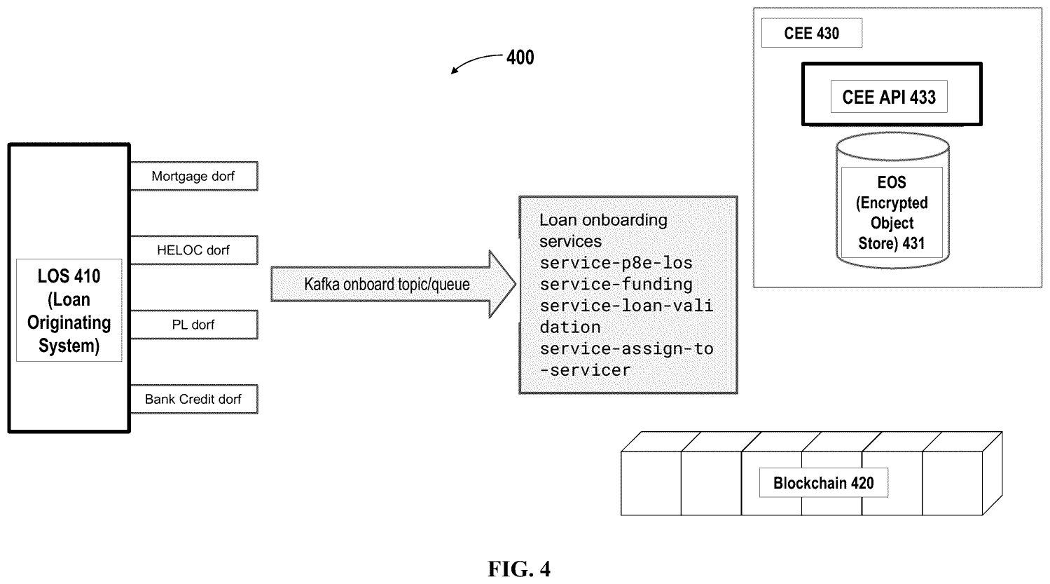

FIG. 4 schematically illustrates a loan onboarding architecture 400 for onboarding loan asset to a blockchain. In some embodiments, the platform and/or the blockchain onboarding system may be implemented in a virtual cloud environment.

In some cases, before onboarding a loan to the blockchain, a loan originator may create a digital loan packet plus digital source documents (e.g., title, credit, income, etc.) for validation purposes. In some cases, the loan data or packets may be digitally signed by the provider. This loan packet may be created through a loan origination system 410 integrated with the blockchain 420. For example, an originator requires the borrower to sign the loan agreement, delivers the required disclosures (Truth-in-Lending Act, etc.), and waits out the rescission period (if relevant). The originator may define any schema for their loan data if the loan data is off-chain. In the cases the loans are to interact with other Blockchain-powered applications (e.g., Portfolio Manager or Marketplace), a scope data model as described above may be utilized. For example, loan data at origination may be stored as a single scope in the Encrypted Object Store 431 while servicing data is recorded in a separate scope(s).

Digital assets can be onboarded to the blockchain by the execution of client-side contracts that the originator writes to consume origination data, verify its completeness, and output data as recorded facts in an encrypted object store private to and hosted by the originator. The Blockchain Contract Execution Environment (CEE) 430 records hashed representations of documents, data, transactions and client-side contracts to the blockchain. Modification or updates of the data may occur through further contract execution on the scope, with validation checks on the input hash of data from the object store against the blockchain to ensure no external data modification has taken place. The various functions may be provided via the CEE API (application programming interface) 433. This beneficially allows the truth of the data verified without the need for trust in the individual originator's data store. For instance, a message payload submitted to Blockchain APIs has the following structure (e.g., in cleartext form as part of the metadata) the sender, audience list, and basic identifiers. The payload may be a cipher text block that contains member information and associated results from the execution of a smart contract.

The platform 400 may provide a plurality of loan onboarding services. For instance, the client-side blockchain contracts may be crafted to require participation by multiple parties, such as an originator and an auditor. For example, an “onboard-to-servicer” contract may involve the originator and the servicer, both verifying the data is complete enough to be transferred to the servicer. All parties participating in a contract execution may be able to read the data. Either party may reject the contract execution. If all parties are in agreement, the resulting data facts are copied to each participant's encrypted data store as part of the head state of the scope.

Every onboarding contract may create a new scope in the EOS 431, with the loan UUID as the scope UUID. The onboarding contract may also establish the initial values for the facts in the scope. In some cases, not all facts will be established during this onboarding process. For example, the validation_results fact may be populated only after the initial run of a loan validation contract. Additionally, not all facts will be established for every loan type. For example, a HELOC loan scope may include the lien_property fact, but a personal loan may not.

The validation command (e.g., service-loan-validation service) may validate the loan as part of the onboarding process. In some cases, the loan validation process may inspect the data for the loan in the EOS 431 and perform a number of checks to ensure that the system underwriting guidelines were met. The validation results may be stored in the validation results fact and may be available to the Portfolio Manager to display to the originator or interested investors. Execution of validation checks in a client-side contract beneficially allows the originator to bypass traditionally manual verification audits.

The “assign-to-servicer” service ensures that the requirements for servicing the loan are met. If the loan data is malformed in some way, the servicing application rejects the contract, and the onus is on the loan origination system 410 to correct the issue.

Encrypted object store 431 may run in a few different configurations based on the needs of the CEE. For example, in a “no external multi-parties configuration,” if the CEE is strictly handling single party contracts, or multi-party contracts where all parties are within the CEE execution environment, a single, privately addressable object store node may be used. The replication feature may be disabled. In an “external multi-parties configuration,” if the CEE execution environment needs to execute multi-party contracts with some parties that exist outside of the EOS 431, an EOS for the CEE execution environment and Replication feature are enabled. In some cases, the EOS requires postgres for persisting data. The CPU and memory requirements may largely depend on the amount of data EOS environment will support.

The blockchain 420 may be accessed via a blockchain node. The blockchain node provides the CEE 433 with a means to read events and send transactions to the distributed blockchain network.

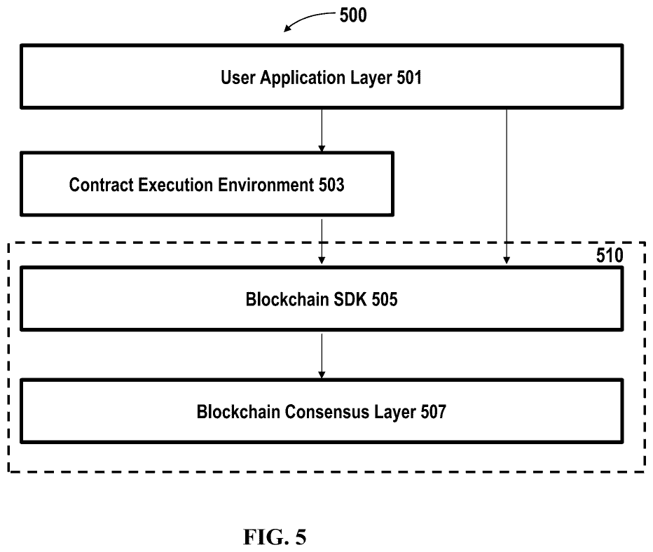

FIG. 5 schematically illustrates an application architecture 500 of the platform. The Application layer 501 may provide a user interface for interacting with one or more blockchain-based applications. For instance, Marketplaces and Exchanges applications may be provided where users buy, sell, and trade things of value. The things of value may include, for example, asset-backed securities, cryptocurrency, or tokenized assets.

The interface layer 501 may comprise a Wallet application. Entities (e.g., organizations, systems, or users) may be required to have an account to conduct business on the Blockchain. An account is represented by the public key portion of a public and private key-pair. Accounts may contain a uniquely identified address, which may be a string value derived from the entity's public key (e.g., in the Bech32 format), thus providing standard blockchain pseudonymity. In an example of Hash transfer transaction where user A is a Hash holder and user B is the recipient. User A holds 100 Hash at address tp1kaczxflvhq4700r0ntdnqlxpu80xdp869seh9e (address is derived from the public key portion of a key pair that user A holds). User B also has generated a key pair and an address from the public key portion of the key pair tp18839rhfk0ql7mdqgn27eeaesmfr9ckpajssuc4. Before user A can send a transfer transaction request to the Blockchain she may be required to sign the transfer transaction. User A uses the private key portion of her key pair to sign the transaction and submits the transaction to the blockchain. The Blockchain validates the transfer transaction signature against User A's public key, verifies that she has an account on the Blockchain, and that the address holds enough Hash to pay transaction fees and to transfer to user B.

A Wallet is where users (e.g., user A and user B) store their key pairs. The Wallet is used to manage key pairs, addresses, and the token-values the addresses hold. In some cases, when using the Blockchain Wallet, HD Wallets may be used. HD Wallets allow entities to create a root mnemonic seed and then derive child keys from the root that can be used to hold value on the Blockchain. For example, user A's address tp1kaczxflvhq4700r0ntdnqlxpu80xdp869seh9e is one of many keys in her HD Wallet. Entities can import, export, or regenerate their Wallet (and any subsequent derived addresses) using the root mnemonic seed. The root mnemonic seed is a secret value that the entity controls and never exposes to the Blockchain system.

The one or more applications may be executable on a plurality of devices. The plurality of devices may include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The application may comprise a graphical user interface (GUI) for a user to access, mange, control a variety of digital asset, conduct transactions and other functions consistent with those described herein. The GUI may be rendered on one or more of the devices.

The Contract Execution Environment layer 503 may be configured for the onboarding and management of private and sensitive information. The Contract Execution Environment (CEE) provides the ability for entities to exchange private data yet still leverage the ownership, immutability and value benefits provides by the Blockchain. The CEE layer is the bridge between the Blockchain and the financial services business logic. The CEE layer may connect directly to a Blockchain node to invoke transactions, query transactions, and listen for events.

The blockchain layer 500 is the Blockchain network and provides a persistent, distributed, immutable, and replicated deterministic state machine. The blockchain layer 500 may comprise the networking (blockchain SDK 505) and consensus layers 507 of the Blockchain including transaction ordering and consensus. The blockchain layer 500 may comprise value and ownership markers leveraged middleware business applications including coins, cryptocurrency, and tokenization, allow for exchange, trading, and settlement of value markers and bridges to fiat currency. The blockchain layer 500 provides bi-lateral exchange implementations using Smart Contracts and provide blockchain primitives such as account authorization, governance, staking, voting, gas and fee processing, telemetry, and node configuration.

The blockchain 510 acts as ledger, registry and exchange for digital assets. The blockchain contains records of all transactions including loan onboarding and loan asset transfers. The blockchain employed by the platform may be a proof-of-stake production blockchain. The blockchain combines the distributed, trustless and immutable characteristics of blockchain with the function of a ledger, registry and exchange. In some embodiments, the blockchain may use a more flexible proof-of-stake consensus method 507 based on the SDK 505.

In some cases, the blockchain layer 510 may use many different proof-of-stake blockchains connected together to support diverse and scalable workloads. Each blockchain created with the SDK 505 may be completely sovereign and autonomous while maintaining the ability to selectively connect with other chains through the use of IBC (inter-blockchain communication). This additional flexibility means that a given application is allowed to build up its own dedicated blockchain network according to the requirements of its own applications supporting the concepts of using many different blockchain instances in aggregate if the application requires it using as few as a single computer/single node up through a full on public global network.

The blockchain layer 510 may support multiple types of integration, both application and smart contract based providing opportunities for high performance or high flexibility depending on the requirements. In some cases, the SDK 505 may be developed using Protobuf with a straight forward message passing and state machine model that provides extension points.

This platform 500 may allow the Blockchain to maintain its network sovereignty, facilitate interaction with other blockchains, and increase scalability. The flexible peer-to-peer networking model may greatly streamline the operational aspects of the Blockchain network while creating a more fault tolerant network through the use of redundant network paths in the peer-to-peer architecture. The platform may include WASM (web assembler) environment allowing smart contracts to be created for the deployment flexibility at the expense of performance and ease of development thereby reducing the cost to maintain and deploy the blockchain, and more accessible for third parties to integrate with while maintaining the sovereignty and control.

### Digital Asset Registration Tool (DART)

Loan transfer has been challenging. The conventional loan document management system may be inefficient. For example, loan data, documents or information may be maintained across disconnected systems (e.g., LOS, servicing system, investor portfolio management system, eVault, etc.). Additionally, manual tracking such as using spreadsheets for portfolio details, purchase advice, wire instructions/dates may add additional friction. The conventional system may require multiple updates to Mortgage Electronic Registration System (MERS) databases for each transfer, and the quality control expenses may be duplicative.

The present disclosure may address the above drawbacks by providing an integrated digital asset registration tool (DART). The DART may be an integrated registry that is configured to track substantially in realtime the control, transfers, assignments and/or ownership of controllable electronic records, such as promissory notes (eNotes) associated with the loan contracts.

In some cases, the DART may obviate the need for paper assignments, bills of sale or other security agreements, or other documentation of physical document transfers. In some cases, the DART may obviate the need to manually register eNotes and loans with an intermediary system which includes Mortgage Electronic Registration System (MERS). In some cases, the DART is configured to enable intra-party blockchain-based transfer of fully-digital, tokenized mortgage assets from a transferor to a transferee, and provide validation that a perfected super-priority control has been granted to the transferee.

In some cases, the EOS is configured to share the encrypted facts and metadata with a loan marketplace module. The loan transactions taking place via the loan marketplace module are recorded substantially in realtime using the DART.

FIG. 6 shows an example of a platform 600 comprising a Digital Asset Registration Tool (DART) 610. The DART 610 may be used for electronic promissory notes (eNotes) Registry. The DART may be configured to track substantially in realtime the control, transfers, assignments and/or ownership of eNotes associated with the loan contracts.

In some cases, the DART may comprise eNote registration, tracking and mortgagee-of-record service. The DART may listen to transactions thereby eliminating the need to document marketplace transfers in another system.

In some cases, the blockchain onboarding system 620, the blockchain 630, the vault 640 (integrated or separate eVault), and the integrated registry application 610 may constitute an ESIGN/UETA safe harbor-compliant control system.

The platform may comprise a validation oracle 660 where validation results may be digitally signed by a source and added to the blockchain. For instance, electronic Reliance Letter and Diligence results are immediately post close, stored in the EOS and accessible on the loan marketplace. In some cases, the diligence data such as Due Diligence 15E Certification may be transmitted from the originator to the validation oracle along with the loan asset (e.g., eNote), protecting the holder in due course, in addition to the initial insured. Validation may be attached to the asset one time as close to origination as possible, and may travel with the asset through investors on the blockchain. In some cases, the finalized loan validation including electronic RL, review results and reporting and an indemnification policy may become an attribute of the loan asset on the blockchain. The diligence results and origination data may be encrypted and stored in the encrypted object store 640.

The platform manages and trades its loans on the Portfolio Manager and Marketplace 650. To allow these applications to read the loan data in the encrypted object store, the LOS may share the data by permissioning the public keys for the other applications. When the blockchain scope objects are permissioned to another public key, the CEE 620 may replicate the data to the encrypted object store of the other application. Subsequent modifications or alterations of the scope through contract execution may also be replicated to the encrypted object store and keys may be quired to read the scope as described above.

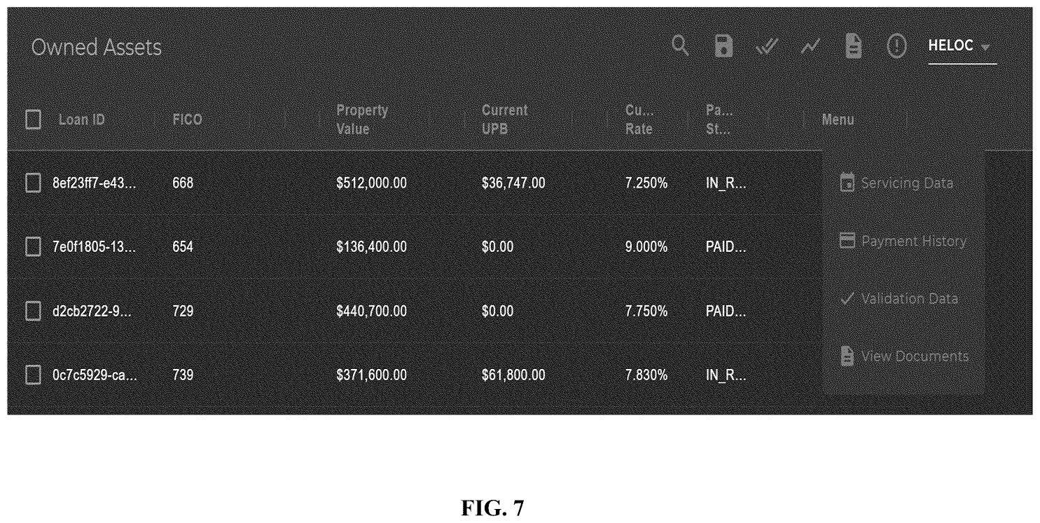

In some cases, the Portfolio Manager 650 may allow participants (e.g., investor A, investor B) to purchase loans via the Loan Marketplace (Portfolio Manager). For instance, a seller (e.g., originator) may pick loans to pool and pledge, sell, and select counterparty. The counterparty may be notified, accept transaction, and purchase loan via the Portfolio Manager. A loan or eNote may be transferred to the investor upon purchase. Validation is attached to the asset one time as close to origination as possible, and travels with the asset through investors on the blockchain. FIG. 7 shows an example of a user interface (UI) provided by the portfolio manager. The UI may provide intuitive tracking or asset management such as viewing real-time servicing data (servicing integration) and current loan data/docs from the blockchain records, providing easy access for trading partners and providing near-real-time asset/funds transfers

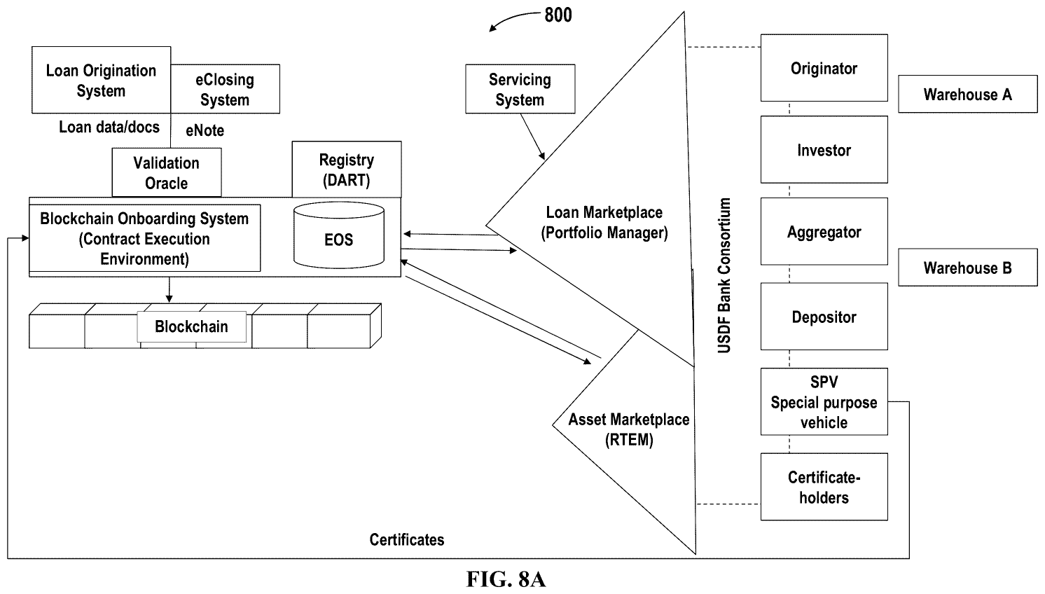

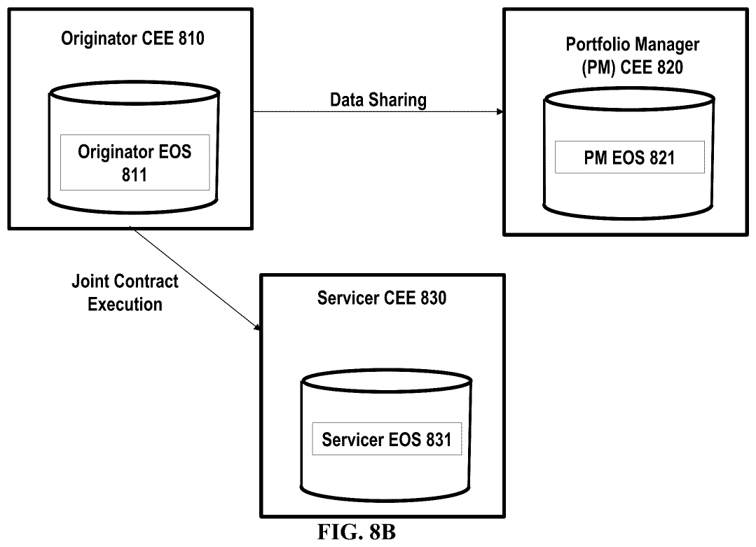

FIG. 8A schematically illustrates a platform 800 with blockchain-based loan validation and the integrated eNote Registration. The result may be a fully-digital, tokenized asset that has the same velocity as the capital it collateralized. The DART or Registry may beneficially provide an ESIGN/UETA safe-harbor compliant control system, thereby eliminating the need to authenticate a security agreement/bill of sale or file a UCC financing statement. For instance, once transfer is completed, the new owner may have fully perfected “superpriority” ownership. The platform may allow USDF consortium members to mint/burn 100% fiat-backed digital markers, for real-time settlement on marketplace trades. The platform may also beneficially allow real-time marketplace to be used to trade securities and provide data to inform pricing in primary and secondary markets.

FIG. 8B schematically illustrates data sharing mechanism in the platform 800. As described above, a loan scope model of the platform may be utilized by a variety of parties. For example, the loan scope model (e.g., blockchain loan scope, encrypted loan data, etc.) may be used by the Servicing application and the Portfolio Manager, allowing joint contract execution and data sharing between these applications. For instance, a loan scope constructed by the originator CEE 810 may be assigned a unique identifier, e.g., Scope ID which may be Universally Unique Identifiers (UUIDs), and stored in the originator EOS 811. Each participant may have their own Key Pair and own instance of a Contract Execution Environment and the EOS. For instance, the portfolio manager may have a key pair uniquely associated with it and own an instance of PM CEE 820 including the PM EOS 821, and the servicing entity may have a key pair uniquely associated with it and own an instance of servicer CEE 830 including the servicer EOS 831.

Data sharing may be through Key-based data sharing and replication and/or joint contract execution in the CEE. In some cases, either of the data sharing method may include replicating to the other party's EOS (e.g., Server EOS 831) and adding the other party as an Audience member. An Audience may refer to the other parties that can decrypt the data, but are not the data owners. Data Owners of the Scope may give permission to other parties to have read-only access of the data. The Audience members may use their own private keys to decrypt the data. The encrypted data along with the audience and key information may be packaged as a single data structure which is a data instance with metadata and encryption (DIME).

The data sharing mechanism and audience information control may be supported by the end-to-end encryption within the blockchain protocol as described above. Submitted data may exist in Submission, Processing/Validation, and Retrieval context in an unencrypted/viewable state assigned to specified audience.

The submission context may be assigned to the creator who submits information to the system. While information may be transferred to another owner, it may be impossible to submit data to the system and not be marked as the owner of it. Changing ownership of an asset can be the same as described above such as by the existing owner adding permission to the new owner followed by the new owner retrieving the data and resubmitting it back to the system to finalize the change in ownership.

### Computer Systems

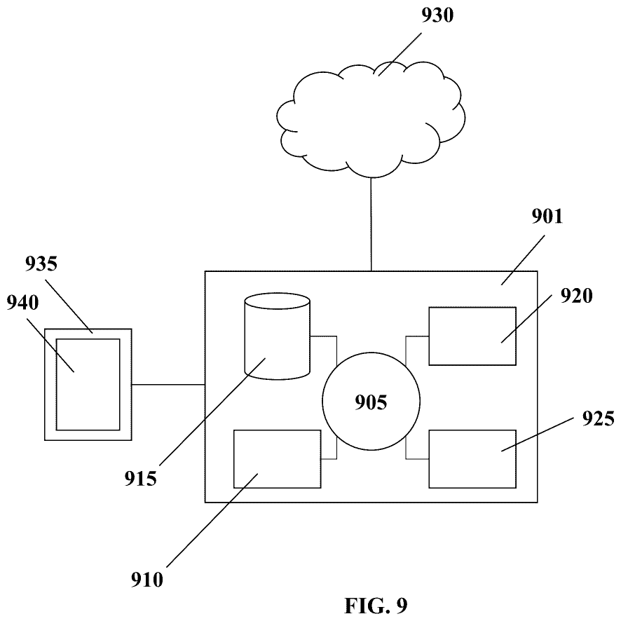

In another aspect, the present disclosure provides computer systems that are programmed or otherwise configured to implement methods of the disclosure. Referring to FIG. 9, the computer system 901 may be programmed or otherwise configured to implement a method for providing a blockchain-based lending or loan processing platform. The computer system 901 may be configured to, for example, implement the blockchain onboarding system, the a smart contract execution environment (CEE) or other components of the platform. The computer system 901 can be an electronic device of a user or a computer system that is remotely located with respect to the electronic device. The computer system 901 can be a cloud server.

The computer system 901 may include a central processing unit (CPU, also “processor” and “computer processor” herein) 905, which can be a single core or multi core processor, or a plurality of processors for parallel processing. The computer system 901 also includes memory or memory location 910 (e.g., random-access memory, read-only memory, flash memory), electronic storage unit 915 (e.g., hard disk), communication interface 920 (e.g., network adapter) for communicating with one or more other systems, and peripheral devices 925, such as cache, other memory, data storage and/or electronic display adapters. The memory 910, storage unit 915, interface 920 and peripheral devices 925 are in communication with the CPU 905 through a communication bus (solid lines), such as a motherboard. The storage unit 915 can be a data storage unit (or data repository) for storing data. The computer system 901 can be operatively coupled to a computer network (“network”) 930 with the aid of the communication interface 920. The network 930 can be the Internet, an internet and/or extranet, or an intranet and/or extranet that is in communication with the Internet. The network 930 in some cases is a telecommunication and/or data network. The network 930 can include one or more computer servers, which can enable distributed computing, such as cloud computing. The network 930, in some cases with the aid of the computer system 901, can implement a peer-to-peer network, which may enable devices coupled to the computer system 901 to behave as a client or a server.

The CPU 905 can execute a sequence of machine-readable instructions, which can be embodied in a program or software. The instructions may be stored in a memory location, such as the memory 910. The instructions can be directed to the CPU 905, which can subsequently program or otherwise configure the CPU 905 to implement methods of the present disclosure. Examples of operations performed by the CPU 905 can include fetch, decode, execute, and writeback.

The CPU 905 can be part of a circuit, such as an integrated circuit. One or more other components of the system 901 can be included in the circuit. In some cases, the circuit is an application specific integrated circuit (ASIC).

The storage unit 915 can store files, such as drivers, libraries and saved programs. The storage unit 915 can store user data, e.g., user preferences and user programs. The computer system 901 in some cases can include one or more additional data storage units that are located external to the computer system 901 (e.g., on a remote server that is in communication with the computer system 901 through an intranet or the Internet).

The computer system 901 can communicate with one or more remote computer systems through the network 930. For instance, the computer system 901 can communicate with a remote computer system of a user (e.g., a merchant or end user). Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 901 via the network 930.

Methods as described herein can be implemented by way of machine (e.g., computer processor) executable code stored on an electronic storage location of the computer system 901, such as, for example, on the memory 910 or electronic storage unit 915. The machine executable or machine readable code can be provided in the form of software. During use, the code can be executed by the processor 905. In some cases, the code can be retrieved from the storage unit 915 and stored on the memory 910 for ready access by the processor 905. In some situations, the electronic storage unit 915 can be precluded, and machine-executable instructions are stored on memory 910.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 901, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 901 can include or be in communication with an electronic display 935 that comprises a user interface (UI) 940 for providing, for example, a portal for a user to interact with the platform. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 905. For example, the algorithm may be configured to generate a visual code that is indicative or representative of a transaction amount of settlement between a first party and a second party.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A blockchain-based lending or loan processing platform comprising:
a blockchain onboarding system comprising a smart contract execution environment (CEE), wherein the blockchain onboarding system is configured to:
(1) automatically process loan data from a loan origination system (LOS) for virtual execution of one or more loan contracts within the CEE, wherein the loan data comprises a plurality of loan-related facts;
(2) encrypt the loan-related facts to generate a plurality of encrypted facts associated with one or more loan assets; and
(3) generate a plurality of hashes for the encrypted facts, wherein the hashes are recorded on a blockchain, and wherein combinations of each encrypted fact with its corresponding hash are deposited in an encrypted object store (EOS) separate from the blockchain.

2. The platform of claim 1, wherein each fact corresponds to a single or discrete piece of data whose hash is to be recorded on the blockchain.

3. The platform of claim 1, wherein the CEE is configured to keep confidential data relating to the one or more loan assets off from the blockchain, while maintaining the ability to use the blockchain for ensuring data integrity.

4. The platform of claim 3, wherein the hashes of the encrypted facts are recorded on the blockchain, and wherein the encrypted facts are not recorded on the blockchain.

5. The platform of claim 3, wherein the EOS is local to or part of the CEE.

6. The platform of claim 1, wherein the plurality of loan-related facts comprise credit scores, borrower information or profile, electronic copies of signed security instruments, copies of electronic promissory notes (eNotes), third party review (TPR) diligence results, and/or terms of a loan.

7. The platform of claim 1, wherein the loan data is originated by an originating party, and wherein the platform is configured to enable the originating party to create a unique wallet having a root key pair comprising of a public key and a private key.

8. The platform of claim 7, wherein the loan-related facts are encrypted using the originating party's public key.

9. The platform of claim 8, wherein the hashes of the encrypted facts are recorded on the blockchain along with the originating party's public key and timestamps.

10. The platform of claim 7, wherein the private key is useable by the originating party or another party who is given permission by the originating party, to decrypt the encrypted facts stored in the EOS.

11. The platform of claim 1, wherein the blockchain contains records of all transactions including loan onboarding and loan asset transfers.

12. The platform of claim 1, wherein a collection of loan-related facts collectively constitute a token that is recorded on the blockchain.

13. The platform of claim 12, wherein the token comprises a non-fungible token (NFT).

14. The platform of claim 12, wherein a collection of tokens collectively constitute a loan asset

15. The platform of claim 13, wherein each token is assigned a unique identifier.

16. The platform of claim 12, 13, or 14, wherein the platform is configured to designate ownership at the token level.

17. The platform of claim 16, wherein the platform is configured to bifurcate ownership of a token between data owner and value owner.

18. The platform of claim 17, wherein the platform recognizes the value owner as an entity that is entitled to the monetary value of the loan asset encompassing the token(s), and permits the value owner to transfer value rights to other parties.

19. The platform of claim 18, wherein the platform recognizes the data owner as an entity that controls the facts encompassed in the token, permits only the data owner to affect the facts in the token, by adding one or more facts, changing one or more facts, or deleting one or more facts, and permits the data owner to share ownership freely such that there can be multiple data owners, and wherein each data owner among the multiple data owners is required to individually sign off on any subsequent changes to the token after the token has been onboarded to the blockchain.

20. (canceled)

21. (canceled)

22. The platform of claim 19, wherein the platform is configured to permit the data owner to grant read-only access to the token for one or more other non-owner parties and enable the one or more other non-owner parties to decrypt the token and view/access the facts within the token, without allowing the non-owner parties to make any changes to the token on the blockchain and wherein any attempted changes made by the non-owner parties that have only read-only access will not be accepted or validated for recording on the blockchain.

23-38. (canceled)
